(19) United States
(12) Patent Application Publication
(10) Pub. No.: US 2019/0148801 A1
(43) Pub. Date: May 16, 2019

(54) DUAL IGNITION STRUCTURE FOR THERMAL BATTERY AND METHOD OF IGNITING THERMAL BATTERY

(71) Applicant: AGENCY FOR DEFENSE DEVELOPMENT, Daejeon (KR)

(72) Inventors: Sang-Hyeon HA, Daejeon (KR); Jae-In LEE, Sejong-si (KR); Ji-Youn KIM, Cheonan-si (KR); Jang-Hyeon CHO, Daejeon (KR); Sang-Sik KIM, Daejeon (KR)

(21) Appl. No.: 16/026,287

(22) Filed: Jul. 3, 2018

(30) Foreign Application Priority Data
Nov. 10, 2017 (KR) 10-2017-0149647

(51) Int. Cl. H01M 10/615; H01M 2/30; H01M 10/04

(52) U.S. Cl. CPC H01M 10/615; H01M 10/0431; H01M 2/30

(57) ABSTRACT

A dual ignition structure for a thermal battery includes a header assembly positioned at an upper part of the thermal battery and including a contact terminal, an upper igniter connected to the contact terminal of the header assembly, an upper assembly supporting the upper igniter; a lower igniter positioned at a lower part of the thermal battery and coupled to the upper igniter in a symmetrical manner, a lower assembly supporting the lower igniter; and a nickel current collector connecting the upper igniter and the lower igniter.

### CROSS-REFERENCE TO RELATED APPLICATION(S)

This application claims priority to Korean Patent Application No. 10-2017-0149647, filed Nov. 10, 2017, the disclosure of which is incorporated herein by reference for all purposes.

### BACKGROUND OF THE INVENTION

### 1. Technical Field

The present invention relates to a dual ignition structure for a thermal battery that is capable of improving ignition reliability and reducing activation time.

### 2. Description of the Related Art

A thermal battery is a primary battery that, when once used, cannot be reused again, and a reserve-type battery capable of being used without self-discharge for a long period of time. The thermal battery are configured with an electrode part such as an anode, a cathode, an electrolyte, a heat source, a current collector, and a pyrotechnic part such as an igniter and a thermal paper. The thermal battery is manufactured by laminating the electrode part, mounting the pyrotechnic part thereon, and then sealing the electrode part and the pyrotechnic part using a casing. The thermal battery is generally activated in such a manner that, when a flame is injected through an inner igniter, heat is generated in the heat source, and the electrolyte is melted due to the heat, thereby generating an electromotive force as a battery. However, when a large number of heat sources are stacked or when a length of the thermal battery is long, the flame possibly does not contact the heat source by the igniter, whereby a situation that the heat source in a lower cell is not ignited frequently takes places.

### SUMMARY OF THE INVENTION

In order to solve the above-described problems, the present disclosure is to provide a dual ignition structure for a thermal battery, in which the thermal battery is prevented from being non-activated or delayed in activation due to low ignition reliability of an igniter, and a structure of the thermal battery is changed from the existing singular ignition type to a dual ignition type, thereby improving ignition reliability and reducing activation time.

The present invention provides a dual ignition structure for a thermal battery, the structure including: a header assembly positioned at a upper part of the thermal battery and including a contact terminal; an upper igniter connected to the contact terminal of the header assembly; an upper assembly supporting the upper igniter; a lower igniter positioned at a lower part of the thermal battery and coupled to the upper igniter in a symmetrical manner; a lower assembly supporting the lower igniter; and a nickel current collector connecting the upper igniter and the lower igniter, in which, when an activation signal is input to the contact terminal of the header assembly, the upper igniter and the lower igniter are simultaneously ignited, thereby shortening an activation time of the thermal battery.

The nickel current collector includes an upper nickel current collector connected to the upper igniter; and a lower nickel current collector connected to the lower igniter.

The upper nickel current collector and the lower nickel current collector are connected in parallel.

The upper nickel current collector and the lower nickel current collector are connected by spot welding.

The nickel current collector has a plate shape with a predefined thickness.

According to another embodiment of the present invention, there is provided a method of igniting a thermal battery using the dual ignition structure for the above mentioned thermal battery, the method comprising: a signal introducing step of introducing the activation signal into the contact terminal of the header assembly; an igniter ignition step of causing the upper igniter and the lower igniter to be simultaneously ignited by the activation signal; a heat source ignition step of causing a heat source of the thermal battery to be ignited due to ignition of the upper igniter and the lower igniter; and an activation step of activating the thermal battery.

With a dual ignition structure for a thermal battery according to the present invention, it is possible to improve ignition reliability and reduce activation time because there is low possibility of non-ignition compared with the existing singular ignition type.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view of an existing thermal battery;

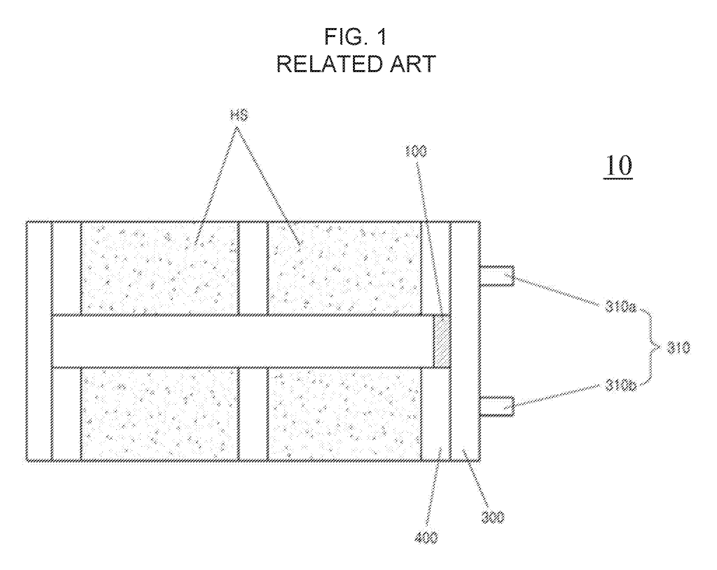

FIG. 2 is a schematic cross-sectional view of a thermal battery with a dual ignition structure according to the present invention;

FIG. 3 is a simplified view of the internal connection relationship of FIG. 2; and

FIG. 4 is a discharge graph comparing activation time between a thermal battery with a dual ignition structure according to the present invention and the existing thermal battery.

### DESCRIPTION OF THE PREFERRED EMBODIMENTS

In order to fully understand the present invention, a preferred embodiment of the present invention will be described with reference to the accompanying drawings. The embodiments of the present invention can be modified in various forms and the scope of the present invention should not be construed as being limited to the embodiments described in detail below. The present embodiments are provided to enable those skilled in the art to more fully understand the present invention. Therefore, the shape and the like of the elements in the drawings can be exaggerated in order to emphasize a clearer explanation. It is to be noted that the same components in the drawings are denoted by the same reference numerals. Detailed descriptions of well-known functions and configurations that may unnecessarily obscure the gist of the present invention are omitted.

The present invention provides a dual ignition structure for a thermal battery 10 and a method of igniting the same, the thermal battery 10 including a header assembly 300 positioned at an upper part of a thermal battery and including a contact terminal, an upper igniter 100 connected to the contact terminal of the header assembly, an upper assembly 400 supporting the upper igniter, a lower igniter 200 positioned at a lower part of the thermal battery and coupled to the upper igniter in a symmetrical manner, a lower assembly 500 supporting the lower igniter, and a nickel current collector connecting the upper igniter and the lower igniter, in which, when an activation signal is input to the contact terminal of the header assembly, the upper igniter and the lower igniter are simultaneously ignited, thereby shortening an activation time of the thermal battery.

The nickel current collector includes an upper nickel current collector 610 connected to the upper igniter 100 and a lower nickel current collector 620 connected to the lower igniter 200, in which the upper nickel current collector and the lower nickel current collector nickel collectors are connected in parallel.

The upper nickel current collector 610 and the lower nickel current collector 620 are connected by spot welding in order to satisfy vibration and impact conditions of the parallel connection, in which the nickel current collector has a plate shape with a predefined thickness.

A method of igniting a thermal battery using the dual ignition structure for the thermal battery according to the present invention includes a signal introducing step of introducing the activation signal into the contact terminal 310 of the header assembly, an igniter ignition step of causing the upper igniter 100 and the lower igniter 200 to be simultaneously ignited by the activation signal, a heat source ignition step of causing the heat source of the thermal battery to be ignited due to ignition of the upper igniter and the lower igniter, and an activation step of activating the thermal battery.

The thermal battery is divided into an upper cell and a lower cell to supply respective electromotive force to the upper and lower parts. A structure of the existing thermal battery may be shown in FIG. The existing thermal battery has a structure in which the igniter 100 is mounted only at the upper part, so that, when the activation signal is input through the header assembly 300, the upper igniter is ignited and the thermal battery is activated. However, when the length of the thermal battery is about 5 cm or more, the heat source may be occasionally not ignited in the lower cell, and the longer the length of the thermal battery, the higher the probability of non-ignition. Especially in the case of the thermal battery, non-ignition of the heat source is a very important factor in terms of safety and reliability of the thermal battery because the non-ignition may possibly cause explosion of the thermal battery. Also, even though the heat source is ignited, there is a disadvantage that the activation time becomes long due to the time difference ignited from the upper part to the lower part.

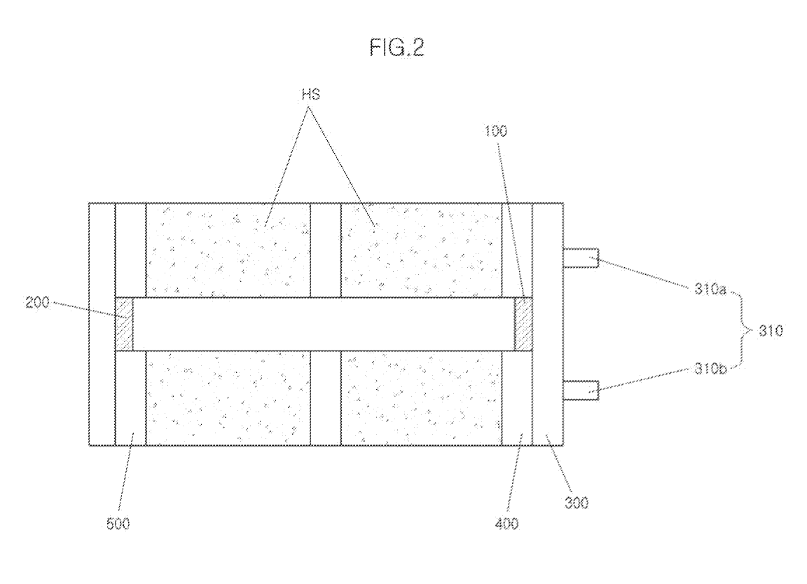

Next, a structure of the thermal battery according to the present invention can be shown in FIG. 2. The thermal battery according to the present invention is configured such that the igniters are mounted in each of the upper and lower parts of the thermal battery so as to face each other. When the activation signal is input through the contact terminal 310 of the header assembly, the upper igniter 100 and the lower igniter 200 connected in parallel are simultaneously ignited. Accordingly, the heat sources that are close to the upper igniter 100 and the lower igniter 200 are ignited respectively, whereby the activation time from the upper cell to the lower cell is shortened.

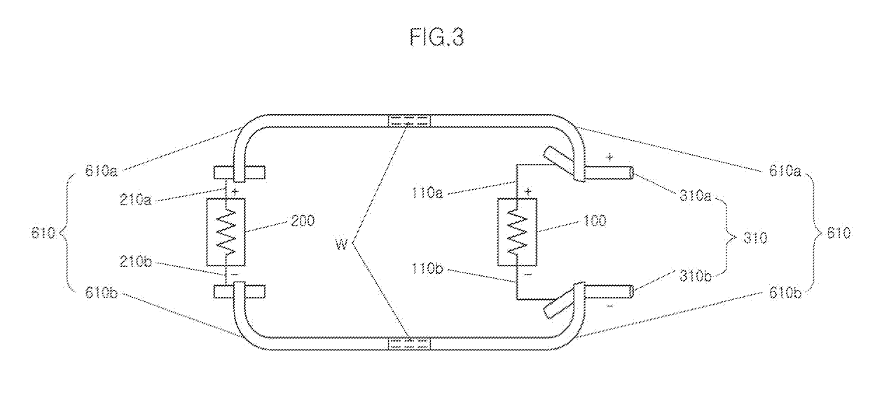

FIG. 3 is a simplified view showing the internal connection relationship of the thermal battery according to the present invention.

As shown in FIG. 3, the thermal battery is configured such that the upper igniter 100 is connected to the contact terminal 310 of the header assembly, the contact terminal 310 is connected to the upper nickel current collector 610, the lower igniter 200 is connected to the lower nickel current collector 620, and the upper nickel collector and the lower nickel collector are welded, thereby connecting the upper igniter 100 and the lower igniter 200 in parallel. Specifically, a positive pin 110a of the upper igniter contacts one side of a positive electrode contact terminal 310a of the header assembly, and a negative pin 110b of the upper igniter contacts one side of a negative electrode contact terminal 310b of the header assembly. One tip end of the upper nickel current collector 610a is wound on the other side of the anode contact terminal 310a and then welded, and one tip end of the upper nickel current collector 610b is wound on the other side of the cathode contact terminal 310b and then welded. An anode pin 210a of the lower igniter 200 is connected to one tip end of the lower nickel current collector 620a, the cathode pin 210b of the lower igniter is connected to one tip end of the lower nickel current collector 620b, and then the other tip ends of the upper nickel collector bodies 610a and 610b and the other tip ends of the lower nickel collectors 620a and 620b are welded in such a manner to connect the same poles.

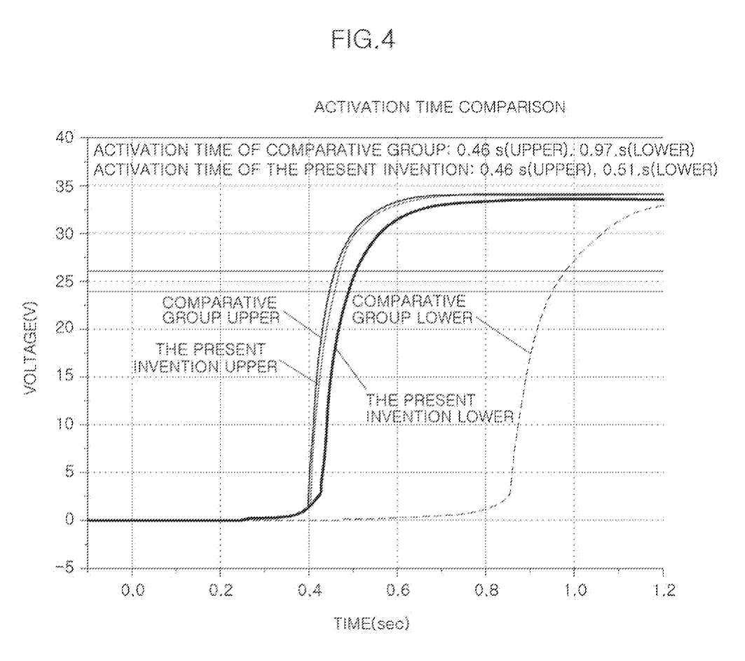

FIG. 4 is a graph comparing activation time between the existing thermal battery and the thermal battery according the present invention, in which the comparative group (the existing thermal battery) is related to a situation in which the lower cell of the thermal battery is not ignited and the activation time of the lower cell is 0.97 seconds. However, according to the thermal battery of the present invention, it is to be noted that the activation time of the lower cell improves to be 0.51 seconds by applying the dual ignition method.

It will be apparent to those skilled in the art that various modifications and equivalent arrangements may be made therein without departing from the spirit and scope of the invention as defined in the appended claims and their equivalents. It is therefore to be understood that the invention is not limited to the specific embodiments shown and described herein. Accordingly, the true scope of the present invention should be determined by the technical idea of the appended claims. It is also to be understood that the invention includes all modifications, equivalents, and alternatives falling within the spirit and scope of the invention as defined by the appended claims.

What is claimed is:

1. A dual ignition structure for a thermal battery, the dual ignition structure comprising:
a header assembly positioned at an upper part of the thermal battery and including a contact terminal;
an upper igniter connected to the contact terminal of the header assembly;
an upper assembly supporting the upper igniter;
a lower igniter positioned at a lower part of the thermal battery and coupled to the upper igniter in a symmetrical manner;
a lower assembly supporting the lower igniter; and
a nickel current collector connecting the upper igniter and the lower igniter, in which, when an activation signal is input to the contact terminal of the header assembly, the upper igniter and the lower igniter are simultaneously ignited, thereby shortening an activation time of the thermal battery.

2. The dual ignition structure according to claim 1, wherein the nickel current collector includes:
an upper nickel current collector connected to the upper igniter; and
a lower nickel current collector connected to the lower igniter.

3. The dual ignition structure according to claim 2, wherein the upper nickel current collector and the lower nickel current collector are connected in parallel

4. The dual ignition structure according to claim 2, wherein the upper nickel current collector and the lower nickel current collector are connected by spot welding.

5. The dual ignition structure according to claim 1, wherein the nickel current collector has a plate shape with a predefined thickness.

6. A method of igniting a thermal battery using the dual ignition structure for the thermal battery of claim 1, the method comprising:
a signal introducing step of introducing the activation signal into the contact terminal of the header assembly;
an igniter ignition step of causing the upper igniter and the lower igniter to be simultaneously ignited by the activation signal;
a heat source ignition step of causing a heat source of the thermal battery to be ignited due to ignition of the upper igniter and the lower igniter; and
an activation step of activating the thermal battery.
